(19) United States
(12) Patent Application Publication
(10) Pub. No.: US 2015/0205824 A1
(43) Pub. Date: Jul. 23, 2015

(54) SYSTEM AND METHOD FOR PROVIDING AGGREGATED METADATA FOR PROGRAMMING CONTENT

(71) Applicant: OpenTV, Inc., San Francisco, CA (US)

(72) Inventor: Glenn Morten, Bellevue, WA (US)

(73) Assignee: OpenTV, Inc., San Francisco, CA (US)

(21) Appl. No.: 14/161,476

(22) Filed: Jan. 22, 2014

(51) Int. Cl. G06F 17/30

(52) U.S. Cl. CPC G06F 17/30312; G06F 17/30952

(57) ABSTRACT

A system and method for providing aggregated metadata for programming content is provided. In example embodiments, data regarding a program is collected from a third party source. The collected data is parsed to identify metadata for the program. The metadata collected from the third party source is merged with official metadata for the program to create aggregated metadata for the program. The aggregated metadata is stored to a metadata warehouse that is searchable.

### FIELD

The present disclosure relates generally to providing metadata, and in a specific example embodiment, to providing aggregated metadata for programming content.

### BACKGROUND

Conventionally, movie and television guides provide information to a viewer regarding what content is available for viewing. However, the information that is presented is often limited because the information is typically from a single source (e.g., an original author or post-production house). As such, the information may become stale thereby making the content it describes less discovered and less popular.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for providing aggregated metadata for programming content may be implemented.

FIG. 2 is a block diagram illustrating an example embodiment of a metadata management system.

FIG. 3 is a flow diagram of an example method for aggregating the metadata.

FIG. 4 is a flow diagram of an example method for providing aggregated metadata to a client device.

FIG. 5 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for providing aggregated metadata for programming content. In example embodiments, data regarding a program is collected from a third party source. The third party source may comprise one or more of a website, feed, tweet, blog, or any other informational source that may maintain data regarding particular programs. The collected data is parsed to identify metadata for the program. The metadata collected from the third party source is merged with official metadata for the program to create aggregated metadata for the program. The official metadata may comprise metadata that is originally created for the program by the program/content creator or provider. The aggregated metadata is stored to a metadata warehouse that is searchable. In some embodiments, the aggregated metadata may be validated and/or edit either automatically or by users prior to storing in the metadata warehouse.

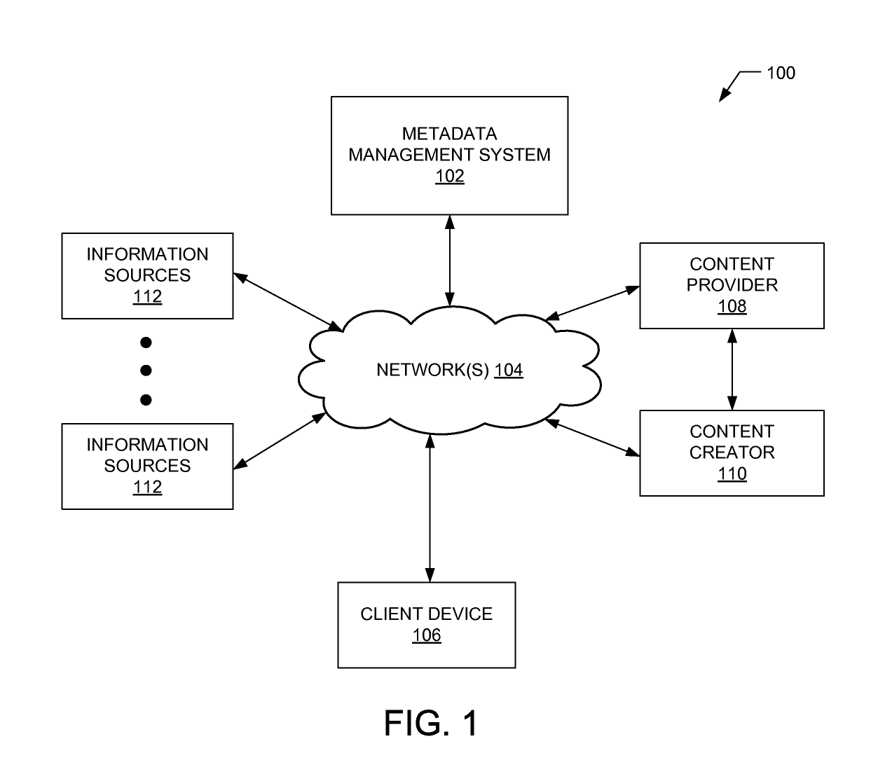

With reference to FIG. 1, a diagram illustrating an example environment 100 in which embodiments of a system for providing aggregated metadata for programming content is shown. The environment 100 comprises a metadata management system 102 coupled via a communication network 104 (e.g., cable network, over-air-broadcast network, the Internet, wireless network, cellular network, satellite network, or a Wide Area Network (WAN)) to a client device 106. The client device 106 may comprise a television, smartphone, laptop, tablet, or any other device that a user may utilize to view programming content (e.g., movies, television shows, videos; also collectively referred to as “program”). In some embodiments, the client device 106 may be communicatively coupled to a set-top box that, in turn, is communicatively coupled to a broadcasting network (e.g., cable network, over-air-broadcast network, satellite network, the Internet).

The metadata management system 102 manages creating and provisioning of aggregated metadata for programming content to the client device 106. In example embodiments, the metadata management system 102 may obtain, filter, and aggregate metadata from various sources. The various sources may include a content provider 108 (e.g., post-production house, cable service provider) and a content creator 110. In some embodiments, the content provider 108 and the content creator 110 may provide the original “official” metadata for each program that may become stale with time.

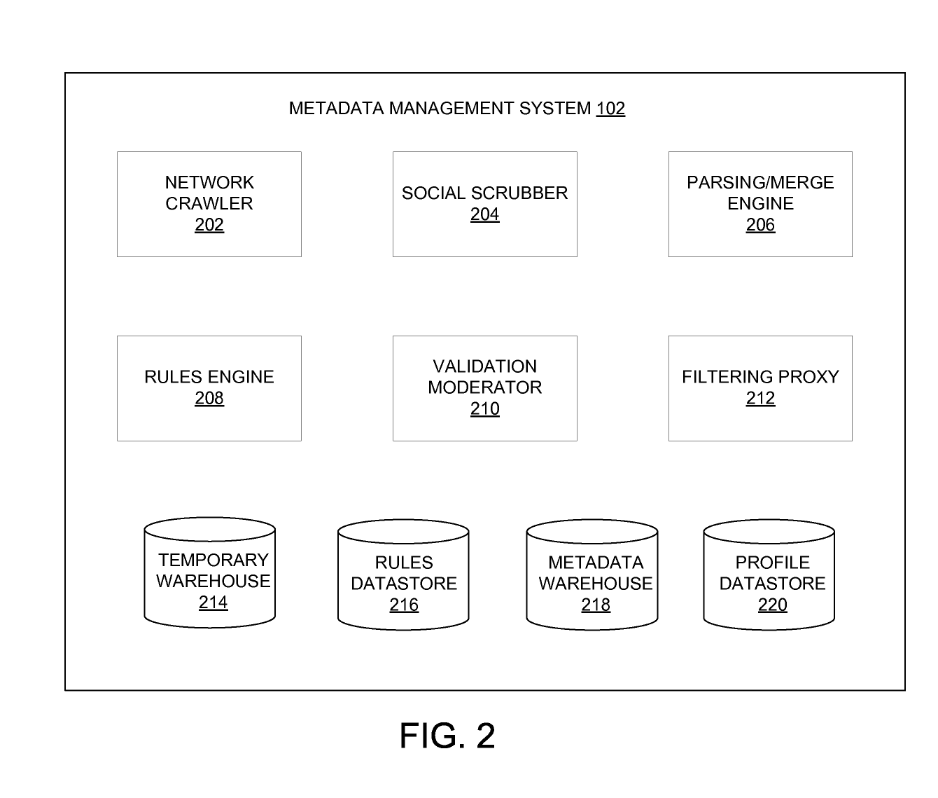

To supplement this official metadata, additional information sources 112 are accessed to obtain a richer variety of metadata. The additional information sources 112 may comprise social networks, social feeds, websites on the Internet, blogs, tweets, or any other third party sources that may provide information on the programming content. The metadata management system 102 collects and curates the metadata from all of these sources to generate the aggregated metadata that may be presented to the user at the client device 106. The metadata management system 102 will be discussed in more detail in connection with FIG. 2.

It is noted that the environment 100 shown in FIG. 1 is exemplary. For example alternative embodiments may comprise any number of client devices 106, content providers 108, content creators 110, and information sources 112 as well as different networks 104.

Referring now to FIG. 2, a block diagram illustrating an example embodiment of the metadata management system 102 is shown. The metadata management system 102 manages the collecting, filtering, and curating of metadata from various information sources to generate the aggregated metadata that is presentable to the user. To enable this, the metadata management system 102 comprises a network crawler 202, a social scrubber 204, a parsing/merge engine 206, a rules engine 208, a validation moderator 210, and a filtering proxy 212 which may be communicatively coupled together. The metadata management system 102 may also comprise (or be coupled to and access) a temporary warehouse 214, a rules datastore 216, a metadata warehouse 218, and a profile datastore 220. It is noted that in some embodiments, the metadata management system 102 or various components of the metadata management system 102 may be located at an office or headend of a cable company, satellite company, or other content service provider.

The network crawler 202 manages the crawling of the network 104 (e.g., Internet) and various network data sources (e.g., Times, Tribune, broadcast network metadata feeds). The network crawler 202 may crawl the Internet looking for data related to different programs. Upon finding data for a program, the network crawler 202 may collect the data and forward the data to the parsing/merge engine 206 for processing (or store the data to a temporary warehouse 214 prior to processing). In some embodiments, the network crawler 202 may have knowledge of the information source 112 and be able to identify the programming content (e.g., program) for which the data is being collected.

The social scrubber 204 manages the crawling or scrubbing (e.g., using crawlers) of social networks, blogs, and feeds for program information. The social scrubber 204 is similar to the network crawler 202 but targeted at blogs, tweets, social feeds, and other data from social networks. In some embodiments, the information or data gathered by the social scrubber module 206 occurs as individuals are watching the content in real time. The data may include user reviews, ratings, comments, indications of what program individuals are watching, and so forth. The individuals may use words that are associated with a particular story line or program which gets detected up by the social scrubber 204. In some embodiments, the social scrubber 204 may have knowledge of the information source 112 and be able to identify the program for which the metadata is being collected. In other embodiments, the social scrubber 204 may identify keywords or other text from the data of the social network (e.g., title, portion of title) to identify the program that the data is directed to. The collected data is forwarded to the parsing/merge engine 206 for processing (or stored to a temporary warehouse 214 prior to processing).

In further embodiments, the social scrubber 204 may comprise a video or image recognition type crawler (e.g., to scrub sites, such as, YouTube or Facebook where videos may be posted). In these embodiments, the social scrubber 204 may identify known visual fingerprints of a particular program from the collected data. The use of the visual fingerprints may help to identify the program for which data is being collected.

The parsing/merge engine 206 performs initial filtering and processing of the data collected using the network crawler 202, the social scrubber 204, as well as data received directly from the content provider 108 or content creator 110 (referred to as “official metadata”). The filtering and processing may, in example embodiments, be based on a predetermined period or event (e.g., based on time or amount of information collected for the program). For example, the parsing/merge engine 206 may remove duplicate data, associate gathered data with a particular program, tag the data, and so forth. These filtering and processing operations may be based on rules from the rules datastore 216. The parsing/merge engine 206 merges the filtered and processed information based on the rules that are created for each program. For example, for one program, the rules may indicate that the parsing/merge engine 206 is not allowed to aggregate information from social or third party sources (e.g., may be a rule that the content creator 110 has that does not allow data from social feeds or third party sources). Another rule may indicate that certain types of metadata or from certain locations are not allowed (e.g., no metadata from tweets). In one embodiment, the filtered and processed information may then be stored into the temporary warehouse 214 and associated with a particular show.

The rules engine 208 manages the rules stored in the rules datastore 216 that are applied by the parsing/merge engine 206. In some embodiments, the rules may be set by the content provider 108 that is providing the content to the client device 106 or by the content creator 110. For example, the rules may not allow any third party information to be merged and aggregated with official metadata. Another rule may be that aggregated metadata may be allowed, but only when moderated. Furthermore, rules about pornography, bad language, or other content to be included or excluded may be established. In some embodiments, a portal may be provided through which the content provider 108 or the content creator 110, for example, may access and edit the rules stored in the rules datastore 216 for each program.

The validation moderator 210 manages the validating and editing of the aggregated metadata. While the collecting and merging of the metadata into the aggregated metadata is automated, in some cases, certain entities (e.g., the content provider 108 or the content creator 110) may want to curate, edit, and/or verify the aggregated metadata before the aggregated metadata is allowed to be presented to the user at the client device 106. In some embodiments, a user associated with the content provider 108, the content creator 110, or the metadata management system 102 may, periodically, access, curate, edit, or verify the aggregated metadata. For example, a portal may be provided through which the content provider 108 or the content creator 110 may access and edit the metadata stored in the temporary warehouse 214 for a particular program. In other embodiments, the validation may occur in an automated manner.

Once the aggregated metadata is merged and, if required, validated, the aggregated metadata is stored to the metadata warehouse 218. The metadata warehouse 218 comprises the aggregated metadata that is searchable and retrievable for presentation to the client device 106. For example, based on a search for a particular actor, a plurality of program may be identified from the metadata warehouse 218.

The filtering proxy 212 retrieves the aggregated metadata based on a request from the client device 106. As such, the filtering proxy 212 receives a request from the client device 106 indicating search criteria (e.g., suggest shows to view or show programs along particular parameters). Alternatively, a program guide may be presented to the user at the client device 106 that shows the official (published) metadata (e.g., from the content provider 108), and the user may indicate that they would like to see more information for a particular program.

In some embodiments, the filtering proxy 212 may access a user profile from the profile datastore 220 for the user. The user profile may indicate, for example, likes, dislikes, preferences, shows that the user has watched before, and specific rules for programs, types of programs, or access to aggregated metadata. For example, a parent may establish a user profile for their child that indicates the types of metadata and programs that the child can discover via the metadata management system 102. In one embodiment, the filtering proxy 212 may be a component located outside of, but coupled to, the metadata management system 102.

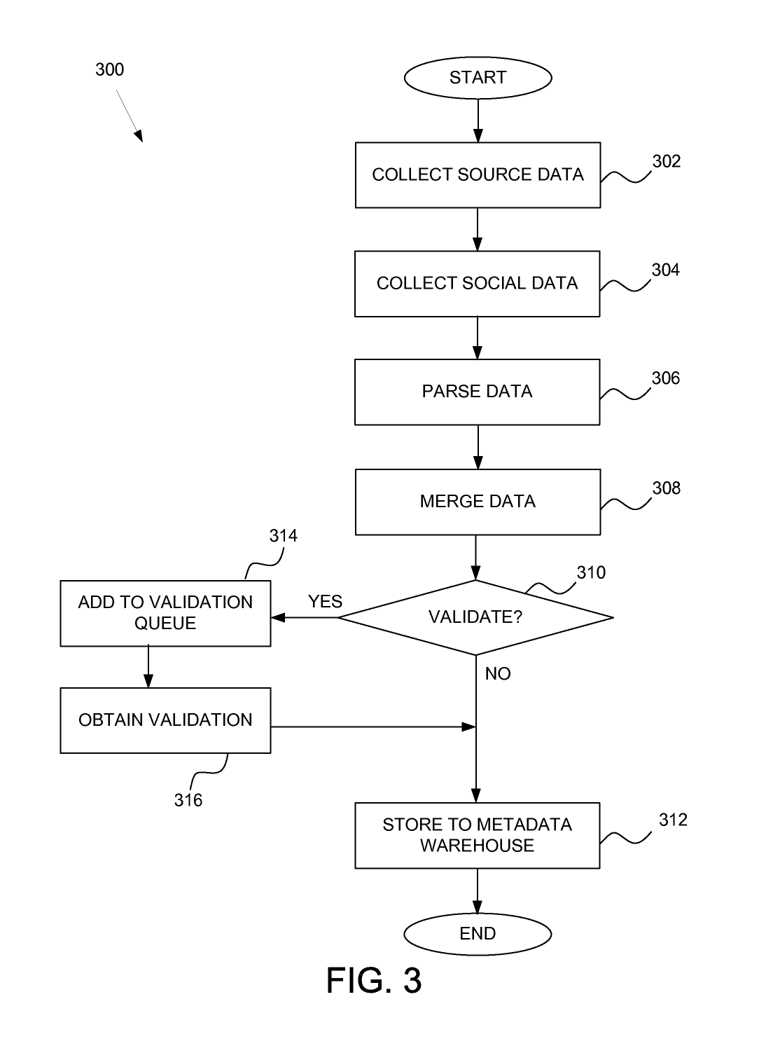

Referring now to FIG. 3, a flow diagram of an example method 300 for aggregating metadata is shown. The operations of the method 300 may be performed by components associated with the metadata management system 102, and may be performed on a frequent, real time, or periodic basis.

In operation 302, data is collected from network sources. In example embodiments, the network crawler 202 crawls network informational sources. Upon finding data for a program, the network crawler 202 may collect the data and forward the data to the parsing/merge engine 206 for processing or store the data to a temporary warehouse 214 prior to processing by the parsing/merge engine 206.

In operation 304, data is collected from social information sources. In example embodiments, the social scrubber 204 scrubs social network sites, feeds, blogs, and tweets to obtain the social data. The social data may include user reviews, ratings, comments, indications of what program individuals are watching, and so forth. The collected social data may be forwarded to the parsing/merge engine 206 for processing or stored to a temporary warehouse 214 prior to processing by the parsing/merge engine 206.

The collected data is then parsed in operation 306. In example embodiments, the parsing/merge engine 206 parses the collected data to access particular metadata. For example, actors, review, comments, titles, storelines, and so forth may be parsed or extracted from the collected data by the parsing/merge engine 206. In example cases, the parsed data may be associated with a particular program.

The various parsed data may be merged with existing metadata in operation 308. As such, the newly parsed data may be combined with previously parsed and merged metadata and/or with official metadata to create the new or updated aggregated metadata. Furthermore, the parsing/merge engine 206 may remove duplicate data and apply other rules from the rules datastore 216 based on the program that the metadata is associated with. It is noted that operations 306 and 308 may be performed periodically (every night), when a particular amount of data is collected, or as the data is being collected in real time. Additionally, the parsing and merging of data may occur with just the data collected by the network crawler 202 or with just the data collected with the social scrubber 204.

In operation 310, a determination is made as to whether the aggregated metadata is to be validated based on rules that correspond to the program for which the aggregated metadata describes. If the aggregated metadata does not need to be validated, then the aggregated metadata may be stored to the metadata warehouse 218 and may be discoverable and retrievable by a user of the client device 106.

If the aggregated metadata is to be validated, then in operation 314, the aggregated metadata may be added to a validation queue. Validation may be obtained in operation 316. The validation may be performed automatically or with a human moderator using the validation moderator 210. In some cases, validation may simply be review and approval of the aggregated metadata. In other cases, validation may include receiving edits to the aggregated metadata. Once validation is complete, the aggregated metadata is stored to the metadata warehouse 218 in operation 312.

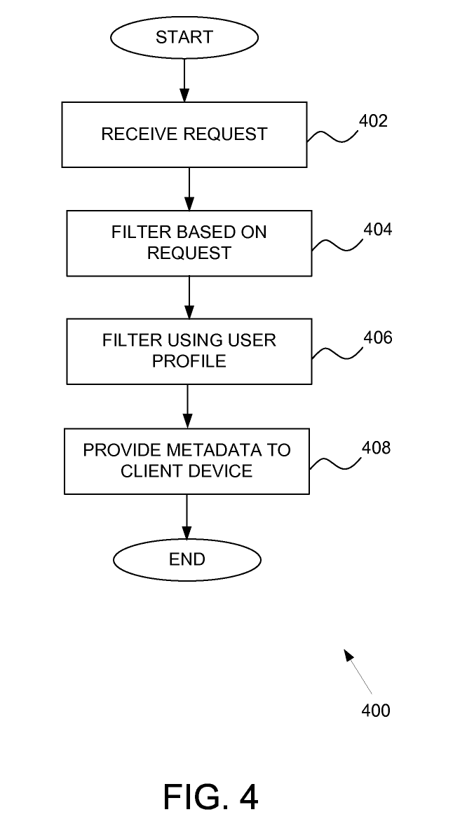

Referring now to FIG. 4, a flow diagram of an example method 400 for providing aggregated metadata to a client device (e.g., client device 106) is shown. A user at the client device 106 may want to discover a program to view or desire to see more information on a particular program (e.g., from a selection on a program guide). As such, the user sends a request for information. The request may include search criteria for discovering a program or may be an indication of a particular program for which the user wants more information. In operation 402, the request is received by the metadata management system 102.

In operation 404, the aggregated metadata stored in the metadata warehouse 218 may be filtered based on the request. In example embodiments, the filtering proxy 212 may receive the request and access the metadata warehouse 218. The filtering proxy 212 may then perform a search or matching process to either discover programs that satisfy the criteria of the request or retrieve metadata for a program identified by the request.

In operation 406, the filtering proxy 212 may use the user profile of the user associated with the request to filter the aggregated metadata. Accordingly, the filtering proxy 212 may access the profile datastore 220 to access the user profile. The user profile may indicate rules, preferences, and viewing history which may be used by the filtering proxy 212 to filter the aggregated metadata into a set of aggregated metadata to be presented to the user. The set of aggregated metadata is then provided to the client device 106 in operation 408

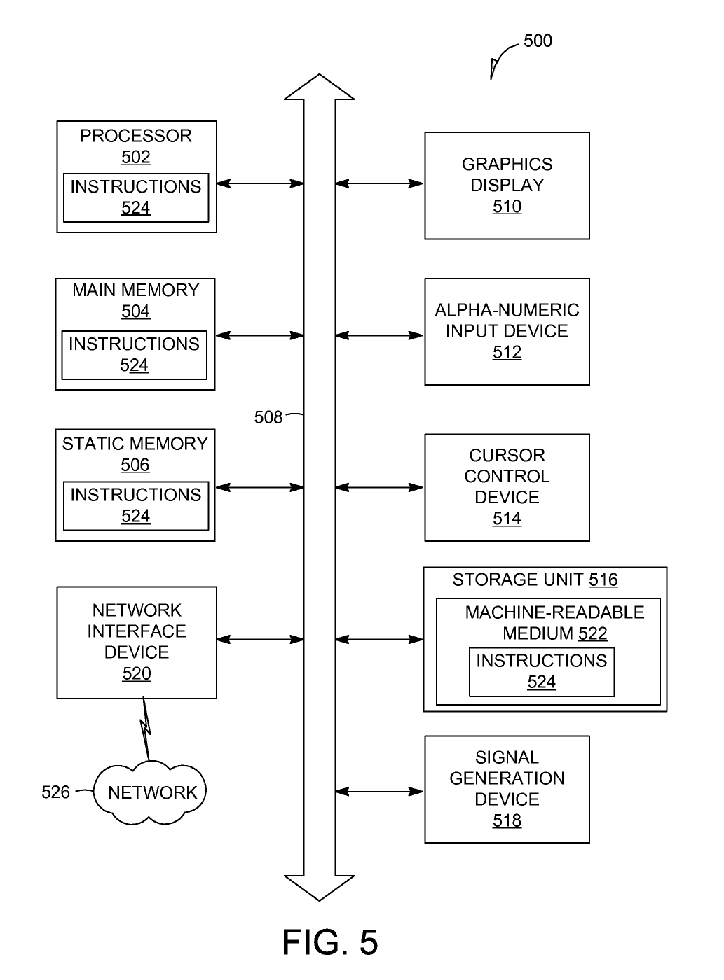

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system and within which instructions 524 (e.g., software, a program, an application, an applet, an app, or other executable code) for causing the machine 500 to perform any one or more of the methodologies discussed herein may be executed. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The machine 500 may further include a graphics display 510 (e.g., a plasma display panel (PDP), a light emitting diode (LED) display, a liquid crystal display (LCD), a projector, or a cathode ray tube (CRT)). The machine 500 may also include an alpha-numeric input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a speaker), and a network interface device 520.

The storage unit 516 includes a machine-readable medium 522 on which is stored the instructions 524 embodying any one or more of the methodologies or functions described herein. The instructions 524 may also reside, completely or at least partially, within the main memory 504, within the processor 502 (e.g., within the processor's cache memory), or both, during execution thereof by the machine 500. Accordingly, the main memory 504 and the processor 502 may be considered as machine-readable media. The instructions 524 may be transmitted or received over a network 526 via the network interface device 520.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 500), such that the instructions (e.g., instructions 524), when executed by one or more processors of the machine (e.g., processor 502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 524 may further be transmitted or received over a communications network 526 using a transmission medium via the network interface device 520 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine 500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
collecting data regarding a program from a third party source;
parsing the collected data to identified metadata for the program;
merging, using a hardware processor, the metadata collected from the third party source with official metadata for the program to create aggregated metadata for the program; and
storing the aggregated metadata to a metadata warehouse that is searchable.

2. The method of claim 1, wherein the collecting the data comprises using a social scrubber to scrub social informational sources, the social information sources being a selection from the group consisting of a social network, blogs, feeds, and tweets.

3. The method of claim 1, wherein the collecting the data comprises using a network crawler to crawl network information sources.

4. The method of claim 1, further comprising identifying a known visual fingerprint of the program from the collected data.

5. The method of claim 1, further comprising receiving a validation of the aggregated metadata prior to storing the aggregated metadata to the metadata warehouse.

6. The method of claim 1, further comprising receiving, from a moderator, edits to the aggregated metadata prior to storing the aggregated metadata to the metadata warehouse.

7. The method of claim 1, wherein the merging the metadata comprises:
accessing a rules datastore;
determining whether a rule is associated with the program;
based on the rule being associated with the program, applying the rule to create the aggregated metadata.

8. The method of claim 1, further comprising:
receiving, from a client device, a request for a set of aggregated metadata;
filtering data in the metadata warehouse using criteria in the request to identify the set of aggregated metadata; and
providing the set of aggregated metadata to the client device.

9. The method of claim 8, wherein the request is triggered by a selection of a particular program from a program guide.

10. The method of claim 8, further comprising:
accessing a user profile of a user of the client device;
determining whether a rule or preference is indicated in the user profile to further filter the data in the metadata warehouse; and
based on the rule or preference being indicated, using the rule or preference to further filter the data to identify the set of aggregated metadata.

11. A system comprising:
a hardware processor;
a crawler to collect data regarding a program from a third party source;
a parsing/merge engine to parse the collected data to identified metadata for the program, and to merge, using the hardware processor, the metadata collected from the third party source with official metadata for the program to create aggregated metadata for the program; and
a metadata warehouse to store the aggregated metadata in a searchable format.

12. The system of claim 11, wherein the crawler comprises a social scrubber to scrub social informational sources, the social information sources being a selection from the group consisting of a social network, blogs, feeds, and tweets.

13. The system of claim 11, wherein the crawler comprises a network crawler to crawl network information sources.

14. The system of claim 11, further comprising a validation moderator to receive a validation of the aggregated metadata prior to storing the aggregated metadata to the metadata warehouse.

15. The system of claim 11, further comprising a filtering proxy to:
receive, from a client device, a request for a set of aggregated metadata;
filter data in the metadata warehouse using criteria in the request to identify the set of aggregated metadata; and
provide the set of aggregated metadata to the client device.

16. A non-transitory machine-readable storage medium in communication with at least one processor, the non-transitory machine-readable storage medium storing instructions which, when executed by the at least one processor of a machine, cause the machine to perform operations comprising:
collecting data regarding a program from a third party source;
parsing the collected data to identified metadata for the program;
merging the metadata collected from the third party source with official metadata for the program to create aggregated metadata for the program; and
storing the aggregated metadata to a metadata warehouse that is searchable.

17. The non-transitory machine-readable storage medium of claim 16, wherein the operations further comprise receiving a validation of the aggregated metadata prior to storing the aggregated metadata to the metadata warehouse.

18. The non-transitory machine-readable storage medium of claim 16, wherein the operations further comprise receiving, from a moderator, edits to the aggregated metadata prior to storing the aggregated metadata to the metadata warehouse.

19. The non-transitory machine-readable storage medium of claim 16, wherein the merging the metadata comprises:
accessing a rules datastore;
determining whether a rule is associated with the program;
based on the rule being associated with the program, applying the rule to create the aggregated metadata.

20. The non-transitory machine-readable storage medium of claim 16, wherein the operations further comprise:
receiving, from a client device, a request for a set of aggregated metadata;
filtering data in the metadata warehouse using criteria in the request to identify the set of aggregated metadata; and
providing the set of aggregated metadata to the client device.
